(19) United States
(12) Patent Application Publication
(10) Pub. No.: US 2016/0300316 A1
(43) Pub. Date: Oct. 13, 2016

(54) HOMEOWNER SYSTEM AND PORTAL

(71) Applicant: Hyphen Solutions, LLC., Addison, TX (US)

(72) Inventors: Brent Byron Beseda, Carrollton, TX (US); Christopher Forrest Sugg, Grapevine, TX (US); Felix Vasquez, JR., Southlake, TX (US)

(21) Appl. No.: 15/094,822

(22) Filed: Apr. 8, 2016

Related U.S. Application Data
(60) Provisional application No. 62/146,117, filed on Apr. 10, 2015.

(51) Int. Cl. G06Q 50/16; G06Q 10/00; G06F 17/30; G06Q 30/00

(52) U.S. Cl. CPC G06Q 50/16; G06Q 30/018; G06Q 30/012; G06Q 10/20; G06F 17/30274

(57) ABSTRACT

Embodiments of systems, methods, and computer-readable storage media for capturing, managing, presenting, and maintaining information about a home are disclosed. A server may generate notifications associated with the project. The notifications may prompt the recipient to capture media content associated with the project. The notification may include a selectable element that, when selected, launches and controls a camera application for capturing the media content, and may indicate various types of media content to be captured. Once the media content has been captured, the media content may be reviewed for compliance with one or more rules, and, once captured and verified for rules compliance, may be provided to a server configured to present the media content and other information associated with a home or project to a user, such as a homeowner.

### CLAIM OF PRIORITY AND RELATED APPLICATIONS

The present application claims the benefit of U.S. Provisional Patent Application No. 62/146,117, entitled “HOME BUYER PORTAL,” filed on Apr. 10, 2015, the contents of which are incorporated by reference herein in its entirety, and is related to U.S. patent application Ser. No. 14/250,339, filed on Apr. 10, 2014, and entitled “CLOSED NETWORK PO DETAIL COMMUNICATION,” the contents of which are incorporated herein by reference in its entirety.

### TECHNICAL FIELD

The present disclosure relates management of homes and buildings, and more particularly to techniques for capturing, processing, and presenting home information.

### BACKGROUND

Purchasing a home, whether new or pre-owned, is one of the largest investments that a person can make. When a person buys a new home, they often visit a design center where they can select various items to be included in the home, such as appliances, flooring, light fixtures, paint colors, counter tops, and the like. Once these items are selected by the homeowner, the home is constructed and, upon completion of the construction of the home, the homeowner takes possession of the home, at which time the homeowner may receive a packet of materials that includes one or more warranty cards, brochures, and/or manuals for the appliances and other features installed in the home. However, the homeowner must then sift through the packet to identify any warranty cards that are present, and then fill out and mail the warranty cards to the appropriate manufacturers (or parties administering the warranties). Some of these warranty cards may require the homeowner to provide information, such as a serial number, model number, etc., which may need to be obtained from the appliances themselves, requiring the homebuyer search through the home to locate the correct item and the requested information. This may be a cumbersome task for the homeowner. Additionally, once the homeowner has located the information and provided the warranty cards to the respective manufacturers, the homeowner must then maintain paper records for each warranty card submitted. For a new home purchase, no warranty may be needed for many years, and, during this period of time, those paper records may become lost, making it difficult for the homeowner to file a claim under the warranty.

For a used home purchase, the homeowner may not receive any information from the seller of the home regarding items included in the home, such as appliances, heating, ventilation, and air conditioning (HVAC) systems, etc., that are under warranty, which may prevent the homeowner from obtaining warranty coverage on some of the items in the home, despite such items being covered under a manufacturer's warranty. Furthermore, homeowners that purchase used homes may not receive any information regarding maintenance performed on the home by the previous owner, such as when the roof was last replaced, how old the water heater is, etc. Thus, the homeowner may not know whether any items in the home are potentially under warranty, may need to be replaced soon, etc.

Other issues may also arise when seeking coverage or repairs under a warranty, or replacement of structures and appliances in a home. For example, the homeowner may not know who installed an appliance in the home. If warranty coverage is denied because the item was not installed properly, the homeowner may need to pay for any repairs or replacements out of their own pocket (e.g., because the installer is unknown). Additionally, even when items that need replacement would not typically be repaired or replaced under warranty, such a light bulbs, fuses, filters, etc., the homeowner may not know the exact type of part needed.

### SUMMARY

Embodiments of systems, methods, and computer-readable storage media for capturing, managing, presenting, and maintaining information about a home are disclosed. As a home is constructed or remodeled, notifications may be periodically generated and provided to various parties associated with the project. The notifications may prompt the recipient to capture media content (e.g., images, video, and the like) associated with the project, such as media content descriptive of, or illustrative of, completion of a phase of the project (e.g., framing of the home is complete, or the kitchen cabinets have been installed). The notification may include a selectable element that, when selected, launches and controls a camera application for capturing the media content. In an embodiment, the notification may indicate or suggest various types of media content to be captured, such as a particular angle or view of the project that should be depicted in the captured media content, or other information. Once the media content has been captured, the media content may be reviewed for compliance with one or more rules. In an embodiment, the one or more rules may ensure that the portions of the project depicted in the media content comply with laws or regulations, such as regulations of the Occupational Safety and Health Administration (OSHA). This may prevent the person capturing the media content from exposing a violation of those rules, and may further be used as a way to audit contractors or other persons involved in the project for compliance with those rules.

The media content, once captured and verified for rules compliance, may be provided to a server configured to present the media content, and/or other information associated with the home or project to a user, such as a homeowner. The interfaces provided by the server may further provide additional functionality to allow a user to view warranty information associated with the home. This information may allow the user to determine whether particular contents of the home are covered under a warranty, and submit a warranty claim. The interfaces further provide tools for managing and tracking the status of warranty claims or other aspects of the home, as described in more detail below.

The foregoing has outlined rather broadly the features and technical advantages of the present disclosure in order that the detailed description that follows may be better understood. Additional features and advantages will be described hereinafter which form the subject of the appended claims. It should be appreciated by those skilled in the art that the concepts and specific embodiments disclosed may be readily utilized as a basis for modifying or designing other systems, methods, processes, and computer-readable storage devices configured to carry out the same purposes as the present disclosure. It should also be realized by those skilled in the art that such equivalent constructions do not depart from the scope of the present disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the scope of the present disclosure.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a block diagram illustrating an embodiment of a system for capturing, processing, and presenting home information;

FIG. 2 is a block diagram of an embodiment of a home management interface for capturing, processing, managing, and presenting home information;

FIG. 3 a block diagram of a notification for capturing home information in accordance with embodiments of the present disclosure;

FIG. 4 is a block diagram of a media content publishing interface for reviewing and submitting media content in accordance with embodiments of the present disclosure;

FIG. 5 is a block diagram of an embodiment of a media content capture interface for reviewing and submitting media content in accordance with embodiments of the present disclosure;

FIG. 6 is a block diagram of an embodiment of a gallery interface for presenting media content in accordance with embodiments of the present disclosure;

FIG. 7 is a block diagram of another embodiment of a gallery interface for presenting media content in accordance with embodiments of the present disclosure;

FIG. 8 is a home inventory interface for accessing and viewing home data representative of contents and components of a home;

FIG. 9 is a block diagram illustrating an embodiment of a warranty interface for submitting a warranty claim according to embodiments of the present disclosure;

FIG. 10 is a block diagram of an embodiment of a warranty inspection interface for scheduling a warranty inspection according to embodiments of the present disclosure;

FIG. 11 is a block diagram of a work order request interface according to embodiments of the present disclosure;

FIG. 12 is a block diagram of a completed work order interface in accordance with embodiments of the present disclosure; and

FIG. 13 is a flow diagram of an embodiment of a method for capturing and providing media content associated with a home in accordance with embodiments of the present disclosure.

### DETAILED DESCRIPTION

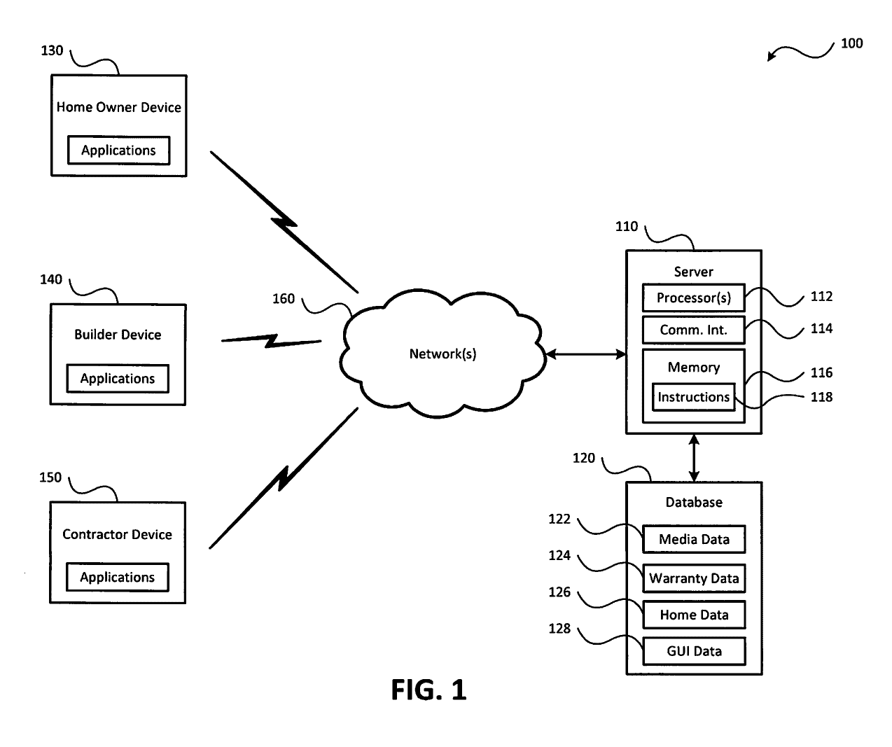

Referring to FIG. 1, a block diagram illustrating an embodiment of a system for capturing, processing, and presenting home information is shown as a system 100. As shown in FIG. 1, the system 100 includes a server 110 and a database 120. Sever 110 includes one or more processors 112, a communication interface 114, and a memory 116. Memory 116 may include read only memory (ROM), random access memory (RAM), one or more hard disk drives (HDDs), one or more solid state drives (SSDs), flash memory, other forms of volatile or non-volatile memory, or a combination thereof. In an embodiment, memory 116 may store instructions 118. In an embodiment, instructions 118, when executed by one or more processors 112, may cause one or more processors 112 to perform the operations described herein with respect to server 110, as described in more detail below. In an embodiment, database 120 may be stored in at least a portion of memory 116. In an additional or alternative embodiment, database 120 may be external to server 110. For example, database 120 may be provided by a network attached storage device, a storage area network (SAN), and the like.

Database 120 may store various types of information to facilitate operations according to embodiment of the present disclosure. For example, database 120 may store media data 122, warranty data 124, home data 126, and graphical user interface (GUI) data 128. In an embodiment, media data 122 may include media content, such as images, videos, floor plan information, or other types of audio or visual content, associated with one or more homes, as described in more detail below. In an embodiment, media data may be stored in association with a job identifier that uniquely identifies a single home. In an embodiment, the job identifier may further identify a community where the home is located, or other information associated with the home. Warranty data 124 may include information identifying components (e.g., appliances, structural features, such as the roof, foundation, etc.) of one or more homes that are under warranty. Additionally, warranty data 124 may further include information indicating the conditions of the warranty. For example, warranty data 124 may indicate a warranty period corresponding to when a particular warranty began, when it expires (e.g., based on a period of time, based on a number of hours of operation or use, etc.), what is covered under the warranty (e.g., whether particular repairs are covered under the warranty or are excluded as normal wear and tear, etc.), the type of coverage provided by the warranty (e.g., whether a repair under the warranty provides replacement with a new part/item, or a refurbished part/item, etc.), warranty claim history (e.g., what claims have been made under the warranty, the result of such claims, etc.), contact information for making a warranty claim (e.g., who does the homeowner contact to make a claim under the warranty), other types of information, or a combination thereof.

Home data 126 may include information associated with structural components and items of the home. For example, home data 126 may include information that identifies each of the appliances or fixtures of a home. This information may include the manufacturer of the appliance of fixture, the model number of the appliance or fixture, the serial number of the appliance or fixture, the party that installed the appliance or fixture in the home, the date the appliance or fixture was installed in the home, the location of the appliance or fixture within the home, an image of the appliance or fixture, and the like. As another example, home data 126 may include information that identifies structural features and components of the home, such as the type of shingles used for the roof of the home, the manufacturer of the shingles, the date the shingles were installed, etc., or the types of materials used to construct the home, information about the foundation of the home, a schematic of the electrical wiring or plumbing of the home, etc.

GUI data 128 may include information for providing various GUIs that facilitate the exchange of information between a user device (e.g., a smartphone, tablet computing device, personal computer (PC), laptop computing device, personal digital etc.) and server 110 in accordance with embodiments of the present disclosure. In an embodiment, server 110 may be a web server, and a user may interact with the various GUIs by exchanging information with sever 110. For example, in an embodiment, a user may utilize a web browser executing on the user's device to navigate to a web page provided by server 110, and the web page may present a GUI to the user. In an additional or alternative embodiment, the user may install an application his/her device, and the application may facilitate communication with server 110 using one or more GUIs. The server 110 may periodically push a portion of GUI data 128 to the user's device, such as to update the one or more GUIs presented by the application to facilitate the exchange of information between the user device and server 110. In an embodiment, communications between the user device and server 110 via one or more of the GUIs may include providing information to server 110, and server 110 may store the information at database 120, as described in more detail below. In an additional or alternative embodiment, communications between the user device and server 110 via one or more of the GUIs may include retrieving information from the database 120, and server 110 may function as an intermediary to make the appropriate calls (e.g., queries, commands, etc.) to retrieve the information from the database 120.

Communication interface 114 may communicatively couple server 110 to one or more networks, such as network 160. In an embodiment, communication interface 114 may be configured to communicate with one or more remote devices using one or more communication protocols (e.g., a cellular communication protocol, an institute of electrical and electronics engineers (IEEE) 802.11 protocol, a transmission control protocol/internet protocol (TCP/IP), an Ethernet protocol, a Bluetooth protocol, a peer-to-peer communication protocol, another type of wired or wireless communication protocol, or a combination thereof). In an embodiment, network 160 may include a plurality of different networks. For example, network 160 may include a local area network (LAN), a wireless LAN (WLAN), a wide area network (WAN), a wireless WAN (WWAN), a cellular communication or data network, a public network, such as the Internet, a private network, another type of network, or a combination thereof.

Network 160 may facilitate communication between server 110 and one or more other devices. For example, as shown in FIG. 1, server 110 may exchange data with homeowner device 130, builder device 140, and/or contractor device 150. In an embodiment, homeowner device 130, builder device 140, and/or contractor device 150 may be a smartphone, a mobile communication device, a tablet computing device, a personal digital assistant (PDA), a laptop computing device, a personal computer (PC), another type of electronic device that is configured according to embodiments of the present disclosure and capable of exchanging data with server 110 via a network, or a combination thereof. In an embodiment, homeowner device 130, builder device 140, and/or contractor device 150 may include one or more applications configured to provide at least a portion of the functionality provided by the embodiments described herein. In an embodiment, the one or more applications may include a web browser application configured to present one or more web pages at a display device (e.g., a display device of homeowner device 130, builder device 140, and/or contractor device 150). In an embodiment, the one or more web pages may include various GUIs, which may be presented based at least in part on data (e.g., GUI data 128) retrieved by sever 110 from database 120. In an additional or alternative embodiment, the one or more applications may include a customized application that has been installed on homeowner device 130, builder device 140, and/or contractor device 150 that is configured to facilitate operations in accordance with one or more embodiments of the present disclosure. In an embodiment, the application and server 110 may be provided by different entities. For example, a third party service provider may provide the application, and server 120 may be provided by a home builder, contractor, and the like. In an additional or alternative embodiment, the application and server 120 may be provided the same entity. In still another additional or alternative embodiment, the one or more applications may include a camera application. The camera application may control a camera that is integrated with or coupled to homeowner device 130, builder device 140, and/or contractor device 150 to facilitate the capture of media content in accordance with embodiments of the present disclosure, as described in more detail below. Further, it is noted that homeowner device 130, builder device 140, and contractor device 150 may include one or more processors and a memory, which may store instructions that, when executed by the one or more processors, cause the one or more processors to perform operations in accordance with one or more embodiments of the present disclosure, which are discussed in more detail below.

During operation, a homeowner may purchase a home from a home builder, or, in the case of a used home, from a previous homeowner. In an embodiment, information associated with the home may be stored in database 120 prior to the homeowner's purchase (e.g., when the purchase is a purchase from a previous homeowner). In such instances, the information stored in database 120 may be updated to reflect the purchase of the home. In an additional or alternative embodiment, database 120 may not include information associated with the home. For example, when the home is a new home being built, database 120 may not contain any information associated with the home at the time the homeowner enters into an agreement with the home builder to construct the home.

During the construction process, database 120 may be populated with media data 122, warranty data 124, and/or home data 126. For example, once the homeowner and home builder agree on the terms of the home purchase, the home builder may provide a schedule to the server 110 using builder device 140. In an embodiment, the schedule may identify one or more milestones associated with the construction of the home. Each of the one or more milestones may be associated with a particular date upon which the milestones are scheduled to be completed. For example, the schedule may identify a first milestone as grading and site preparation (e.g., preparing the lot where the home is to be built), and may identify a first date upon which the first milestone is to be completed, and may identify a second milestone as foundation construction (e.g., preparing and constructing the foundation of the home) to be completed on a second date. Additional milestones may include framing the home, drying in the home (e.g., making the home substantially weather proof), sheet rocking the home, roughing in electrical and/or plumbing of the home, painting the home, installation of brick and/or siding for the home, landscaping, pouring the driveway, trim work (e.g., baseboards, crown molding, door and window trim, etc.), installation of cabinetry and appliances, installation of flooring, or other tasks. In an embodiment, the schedule, including milestones and due dates, may be stored as part of home data 126.

Server 110 may be configured to periodically query home data 126 to identify one or more homes having milestones associated with upcoming due dates. For example, server 110 may query home data 126 to identify milestones that are to be completed within a threshold time period (e.g., 1 day, 1 week, etc.). Upon identifying the one or more homes with upcoming milestone due dates, server 110 may generate one or more notifications. The notifications may include a job identifier, a task identifier, and a selectable element. In an embodiment, the job identifier may include information that uniquely identifies a home corresponding to one of the identified milestones. In an embodiment, the task identifier may include information that indicates a task to be completed in connection with the notification, as described in more detail below. In an embodiment, the selectable element may be used to launch a camera application of an electronic device (e.g., a camera of homeowner device 130, builder device 140, or contractor device 150), and to control a camera of the electronic device to acquire media content that may be subsequently provided to server 110 for storage at database 120 (e.g, as media data 122), as described in more detail below.

In another embodiment, server 110 may transmit the notifications to one or more electronic devices (e.g., homeowner device 130, builder device 140, or contractor device 150) associated with different entities via network 160. For example, a first notification may be associated with a home being built by a first home builder, and a second notification may be associated with a home being built by a second home builder, where the first and second home builders are different entities. As another example, a first notification may be provided to a home builder, while a second notification may be provided to a contractor. As yet another example, server 110 may provide notifications to one or more homeowners, one or more home builders, one or more contractors, or a combination thereof. In an additional or alternative embodiment, server 110 may transmit multiple notifications to one or more electronic devices of a single entity via network 160. For example, a home builder may have multiple homes they are building, and server 110 may provide notifications to the home builder for each of the homes being built. In an embodiment, different notifications may be associated with different job identifiers (e.g., when the notifications are associated with different homes being built). In an embodiment, different notifications may be associated with different task identifiers (e.g., when the milestones corresponding to each of the notifications are different), or may be associated with the same task identifiers (e.g., when the milestones corresponding to each of the notifications are the same). In an embodiment, a single notification may include multiple task identifiers (e.g., when multiple milestones for a single home are coming due). In an embodiment, a notification may include multiple selectable elements. For example, a notification including a plurality of task identifiers may comprise a plurality of selectable elements (e.g., one selectable element for each of the plurality of task identifiers). Selection of one of the plurality of selectable elements may control capturing of media content to be associated with a corresponding task identifier, while selection of another one of the plurality of selectable elements may control capturing of media content to be associated a corresponding other one of the plurality of task identifiers. In an additional or alternative embodiment, a single selectable element may be included in a notification having a plurality of task identifiers, and a GUI may be used to designate particular media content as being associated with particular ones of the plurality of task identifiers.

The notification may be received at a user device (e.g., homeowner device 130, builder device 140, or contract device 150). In an embodiment, the notification may be a request to capture media content (e.g., images, video, etc.) associated with a home (e.g., the home identified by the job identifier). In an embodiment, the job identifier included in the notification may identify an address of the home associated with the notification. In an additional or alternative embodiment, the job identifier may identify the home using a user-specific identifier. For example, a home builder or contractor may create its own unique identifier for a job site, such as home construction site, and that identifier may be used as the job identifier. In an embodiment, the job identifier may also indicate a community where the home is located. As explained above, the notification includes one or more task identifiers. In an embodiment, the one or more task identifiers may prompt a user viewing the notification regarding the type of media content that is to be captured in connection with the notification. For example, the task identifier may prompt the user to capture an image of a serial number of an appliance that has been installed, capture an image of the installed appliance, capture an image of the job site from one or more viewpoints (e.g., capture an image of the front of the home and capture an image of the back of the home), capture a video of a walkthrough of the home, capture a video of a test run of an installed sprinkler system, or another task. In an embodiment, the notification may indicate the date that the task is to be completed, or was completed, which may indicate to the user whether the media content is able to be captured immediately (e.g., for completed tasks), or at a subsequent date (e.g., for tasks that will be completed in the near future, but are not yet completed at the time of the notification). In an embodiment, the notification may further include information associated with the task. For example, the notification may include information indicating a contractor that is performing a job in connection with the task, such as installing cabinets in the home, where the task included in the notification is taking a picture of the installed cabinets. The information may include contact information for the contractor.

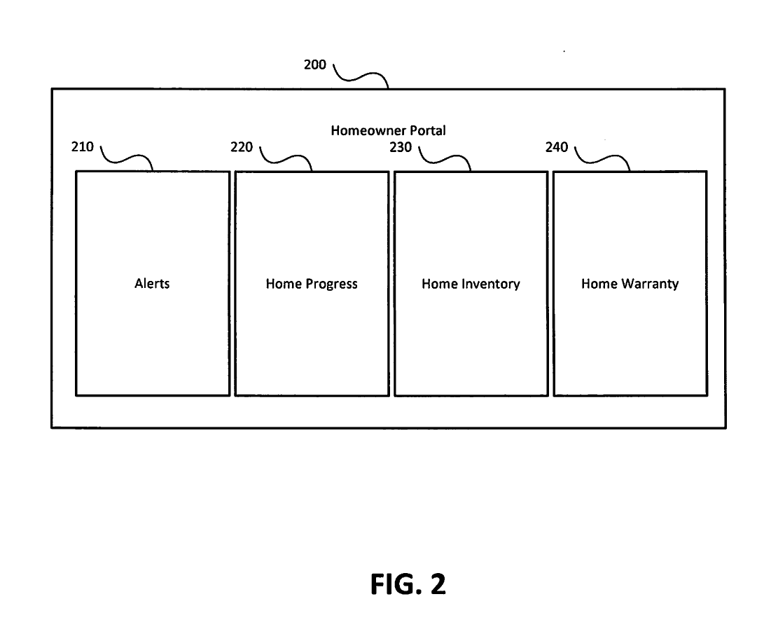

As explained above, the notification includes a selectable element that, when selected, controls a camera application of the user's device to capture the media content. When the task has been completed, the recipient may visit the job site identified by the job identifier, and may navigate an application (e.g., a web browser-based application or standalone application) executing on the device to a notifications GUI. For example, and referring to FIG. 2, a block diagram of an embodiment of a home management interface for capturing, processing, managing, and presenting home information is shown as a home management interface 200. In an embodiment, the home management interface 200 may be displayed as a home screen of an application, such as a standalone application installed on the user's device (e.g., homeowner device 130, builder device 140, or contract device 150). In an additional or alternative embodiment, home management interface 200 may be presented as a landing page of a website, such as a website provided by a server (e.g., server 110 of FIG. 1, or another server). As shown in FIG. 2, the home management interface 200 includes a menu of navigation elements including an alerts navigation element 210, a home progress navigation element 220, a home inventory navigation element 230, and a home warranty navigation element 240. Exemplary aspects of home progress navigation element 220, home inventory navigation element 230, and home warranty navigation element 240 are described in more detail below. Selection of alerts navigation element 210 may cause the application to present one or more received notifications at a display of the user device. In an embodiment, the notifications may be presented as a list of selectable elements, and selection of one of the selectable elements of the notifications list may cause the application to present the corresponding notification.

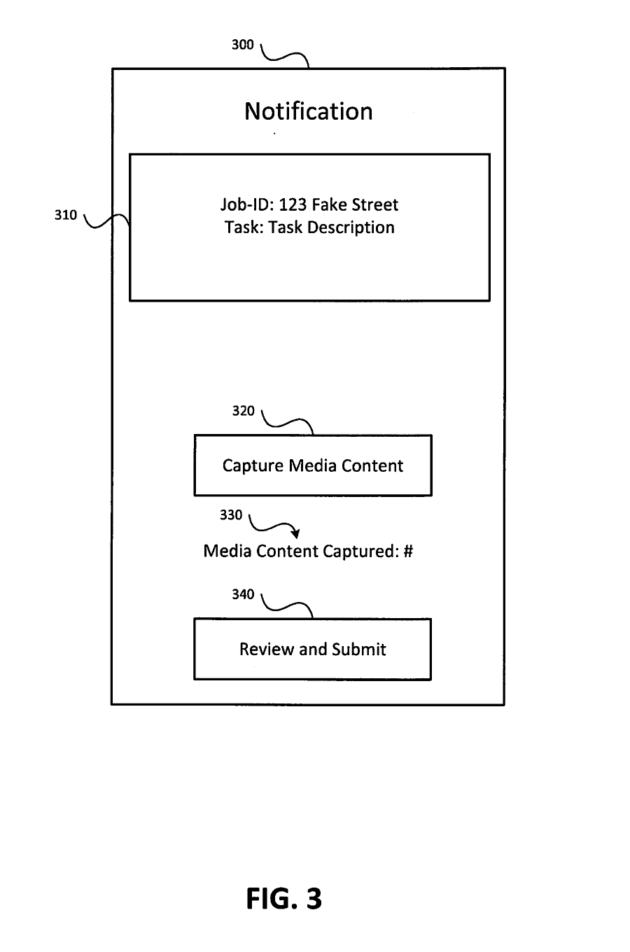

Referring to FIG. 3, a block diagram of a notification for capturing home information in accordance with embodiments of the present disclosure is shown as a notification 300. Notification 300 includes a job and task identifier region 310, a selectable element 320, and a capture media content summary region 330. Job and task identifier region 310 may be configured to display the job identifier and the task information to the user. As explained above, the job identifier may signal to the user the location where the identified task is to be performed (e.g., what address, community, home, etc.). The task information may indicate the particular media content to be captured. For example, as described above, the task information may instruct the user to capture images and/or video of a particular component of the home, such an installed appliance, information associated with a component of the home, such as serial number of an installed appliance, video content of an aspect of the home, such as a walkthrough of the home or video demonstrating that a system of the home works properly, or a combination of different tasks and/or media types.

When the user arrives at the job site identified by the job identifier, the user may select selectable element 320 included in notification 300. In response to detecting the selection of selectable element 320, the application may launch the user device's camera application to initiate the capture of media content via the camera of the user device. For example, the user may capture one or more images using the camera and the camera application. In an embodiment, the application may access the user device's image gallery upon detecting selection of selectable element 320 to determine which images in the image gallery of the user's device are already present. This may enable the device to distinguish images captured after selection of selectable element 320 images captured prior to selection of selectable element 320, which enables the application to identify the images captured in response to the notification. In an embodiment, the images captured in response to the notification may be identified by analyzing the names of the images stored in the image gallery. For example, the images in the user device's image gallery may be automatically named using a naming convention, such as a prefix followed by a number (e.g., DSC-0001, where DSC is the prefix and 0001 is the number), where the number is incremented each time additional images and/or video are captured using the camera. By noting the highest number image of the gallery before capturing the media content associated with notification 300, the application may then monitor the image gallery for media content having a higher number to identify the media content captured in connection with the task indicated in the task information of the job and task identifier region 310. In an embodiment, the application may determine a number and type of media content items captured subsequent to selection of selectable element 320, and information representative of the number of media content items may be presented in capture media content summary region 330. For example, if the user captures 3 images and 1 video, capture media content summary region 330 may be updated to indicate that the user has captured 3 images and 1 video in connection with notification 300.

When the user has finished capturing media content, the user may return to the notification 300. In an embodiment, the user may be returned to notification 300 automatically. For example, in an embodiment, notification 300 may include information that indicates the number and type of media content to be captured, and, in response to detecting that the user has captured the appropriate quantity of each type of requested media content, the application may close the camera application and return the user to notification 300. In an embodiment, if the user returns to notification 300 without capturing the requested quantity and/or type of media content, capture media content summary region 330 may be updated to indicate the quantity and/or type of media content that remains to be captured. The user may then select selectable element 320 and capture the additional media content.

In an embodiment, when the user is returned to notification 300 and all requested media content has been captured, the media content may be automatically transmitted to a server (e.g., server 110 of FIG. 1), and the server may subsequently store the media content in a database (e.g., database 120 of FIG. 1). In an embodiment, the user device may be a smartphone or another type of wireless communication device configured to communicate data over a cellular communication network, and the media content may be transmitted to the server using a cellular data network. In an additional or alternative embodiment, the user device may be a laptop, PDA, tablet computing device, and the like, and may store the media content until the user device is communicatively coupled to a network, such as a wireless network (e.g., fidelity (Wi-Fi) network), or a wired network, and, upon establishing a communication link with the network, may initiate transmission (either automatically or at the request of the user) of the media content to the server, which may store the media content at the database.

In an embodiment, notification 300 may include a review and submit selectable element 340. In response to detecting a selection of review and submit selectable element 340, the application (e.g., the browser-based application or standalone application) may present a GUI at the user device (or a device coupled to the user device) that presents the media content that was captured in response to notification 300. In an embodiment, the media content presented may be determined based on the information obtained prior to capturing the media content. For example, assume that prior to capturing the media content, the highest number for media content in the media gallery of the user device was “0100,” and that after the media content was captured and the user was returned to notification 300, the highest number of the media content in the media gallery was “0102.” The application may determine that the user captured two items of media content, and may present the media content associated with numbers “0101” and “0102” to the user in response to selection of review and submit selectable element 340. It is noted that the names of the two media content items may include a prefix, such as “DSC” (e.g., the filenames for the two items of media content may be “DSC-0101” and “DSC-0102,” respectively).

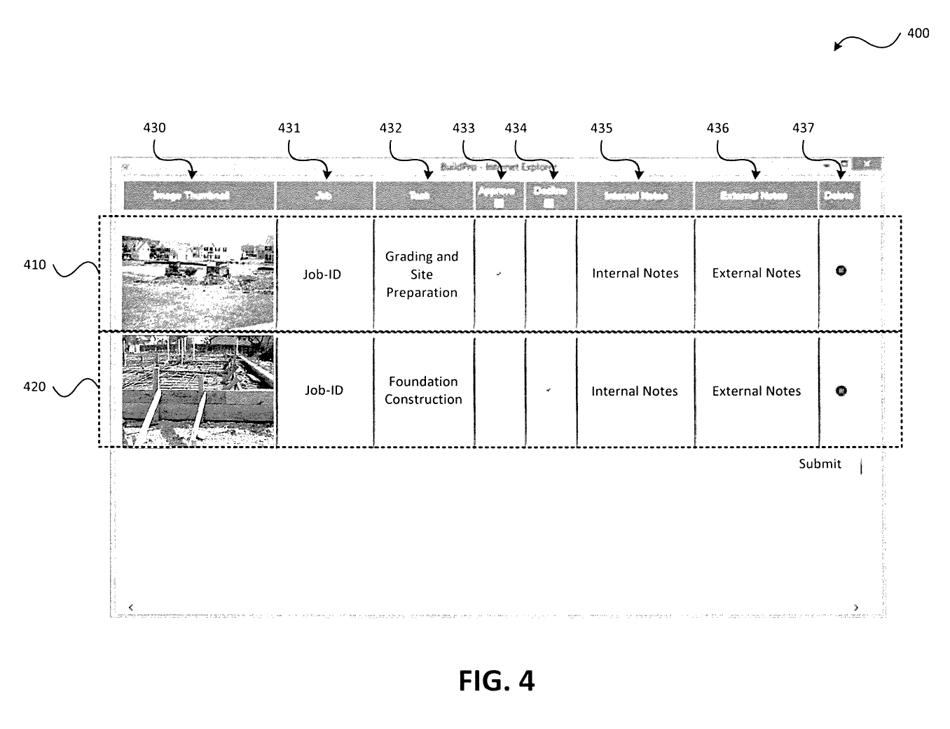

Referring to FIG. 4, a block diagram of a media content publishing interface for reviewing and submitting media content in accordance with embodiments of the present disclosure is shown as a media content publishing interface 400. In an embodiment, media content publishing interface 400 may present media content information in a row and column format, where rows of media content publishing interface 400 represent items of media content, and columns of media content publishing interface 400 provide various information about the displayed media or request information from the user regarding the media content. For example, as shown in FIG. 4, media content publishing interface 400 includes columns 430, 431, 432, 433, 434, 435, 436, and 437. For each row, column 430 may include a thumbnail image of media content captured in response to a notification (e.g., notification 300 of FIG. 3), column 431 may include the job identifier information, column 432 may include the task information, column 433 may include an approve selectable element (e.g., a check box, radio button, or equivalent input mechanism), column 434 may include a decline selectable element (e.g., a check box, radio button, or equivalent input mechanism), column 435 may provide a text box for inputting notes that are to be viewed by the content creator (e.g., the user that captured the media content, and particular third parties, such a contractor or home builder, but not a homeowner), column 436 may provide a text box for inputting notes that are to be viewed by a party other than the content creator (e.g., when the builder or contractor captures the media content, the notes input into column 436 may be viewed by a homeowner), and column 437 may provide a delete image control for deleting a particular item of media content.

As shown in FIG. 4, media content publishing interface 400 may present multiple items of media content for review and approval. For example, row 410 presents a thumbnail and information for a first item of media content, and row 420 presents a thumbnail and information for a second item of media content. In an embodiment, the media content presented in the different rows of media content publishing interface 400 may be associated with the same job identifier. In an additional or alternative embodiment, the media content presented in the different rows of media content publishing interface 400 may be associated with different job identifiers. In an embodiment, the media content presented in the different rows of media content publishing interface 400 may be associated with the same task. In an additional or alternative embodiment, the media content presented in the different rows of media content publishing interface 400 may be associated with different tasks.

In an embodiment, the decision to approve or decline a particular item of media content may be based on one or more rules. In an embodiment, the at least one rule may be associated with one or more laws or rules issued by a government agency or organization. For example, the at least one rule may be associated with a building code specifying standards for various aspects of a structure, and a determination of whether one or more items of media content satisfy the at least one rule may be determined based on whether information depicted in the media content complies with the building code(s). As another example, the Occupational Safety and Health Administration (OSHA) is a governmental agency charged with enforcement of safety and health legislation, and OSHA regulations require that workers in an area where they may be subjected to falling debris wear a protective helmet, such as a hard hat. In an additional or alternative embodiment, the at least one rule may be associated with one or more rules of a professional organization.

In an embodiment, the application may be configured to automatically determine whether to provide the one or more images to a remote database (e.g., the database 120 of FIG. 1) based on whether the one or more items of media content satisfy at least one rule. For example, the application may be configured to determine, based on the task identifier, a particular phase of the home construction process, and may query the remote database (e.g., the database 120 of FIG. 1) to determine whether the particular phase is associated with an inspection process, as may be required by a state or local government agency (e.g., to ensure compliance with the relevant provisions of the building code). If the inspection has been performed, and the home passed the inspection, the application may determine that the at least one rule is satisfied, and may provide the images to the remote database. In an additional or alternative embodiment, the notification may include information that indicates whether the inspection has been completed and passed, and the determination by the application may be performed without querying the remote database.

In an additional or alternative embodiment, the application may be configured to prompt the user for input regarding whether the media content satisfies the at least one rule. The application may determine the at least one rule based on the task information, and may prompt the user to provide one or more inputs that indicate whether the media content satisfies the at least one rule. For example, if the media content is an image showing the progress of the framing of the home (e.g., the first story of a 1-story home is complete), the application may prompt the user to provide an input indicating whether any workers are present in the image, and, if the input indicates that workers are present in the image, may further prompt the user to provide an input indicating whether any of the workers are not wearing a protective helmet (e.g., as required by a relevant OSHA regulation). If the input indicates that at least one of the workers is not wearing a protective helmet, the media content may not be provided to the remote database, and the user may be prompted to retake the image. If the input indicates that all of the workers present in the image are wearing protective helmets, or that no workers are depicted in the image, the application may provide the image to the remote database, or may enable the corresponding approve selectable element in the column 433, thereby allowing the user to approve the image for uploading to the remote database.

In an embodiment, the deny selectable elements included in the column 434 may be used to prevent the application from providing media content to the remote database. For example, a user may select the deny selectable element when particular media content does not satisfy the at least one rule. Other examples of rules that may be checked prior to providing media content to the remote database may include rules that specify a threshold image quality, a threshold resolution, a threshold number of images and/or videos, or another characteristic of the image, such as lighting (e.g., is the subject matter intended to be shown by the image or video visible). Still other examples of rules may include whether the image contains information of an undesired item, such as trash or other items that the user does not want included in the image that is ultimately presented to the homeowner. In an embodiment, the at least one rule may be presented to the user as a graphical overlay (e.g., on top of the image), or may be presented in a separate portion of the GUI that is visible while the image or other media content is viewable (e.g., present the image in a first portion of the GUI and the at least one rule in a second portion of the GUI).

The text boxes included in columns 435 and 436 may enable the user to input notes regarding the media content, where the internal notes are hidden from certain third parties, and the external notes are visible to the third parties. For example, the internal notes may be used to communicate information within a single entity, such as between personnel of a home builder, or between entities, such as between a contractor and the home builder, while the external notes may be shared with a third party, such as a homeowner. In an embodiment, the external notes may provide the third party with a brief description of what is depicted in the corresponding media content. In an embodiment, a server (e.g., server 110 of FIG. 1) may transmit a message to a party in response to receiving new media content associated with a home. For example, upon receiving media content indicating that framing of a home is completed, the server may transmit a message to the homeowner informing the homeowner that the home has been framed, and that images of the framed home have been uploaded to a system (e.g., system 100 of FIG. 1) and are available for viewing via a gallery interface. The user, upon receiving the message, may then navigate to appropriate gallery interface to view the media content of the framed home. In an embodiment, the message may include a link that, when selected, navigates an application on the user's device to the appropriate gallery interface, or to a portal (e.g., home management interface 200 of FIG. 2) provided by the system. It is noted that in some embodiments, a user may need to provide a username and password prior to accessing home information via the portal, and/or prior to providing information (e.g., media content, etc.) to the system.

The selectable elements provided in column 437 may enable the user to delete an item of media content. For example, if the user desires to decline acceptance of media content, the user may delete the media content using a delete selectable element in column 437 of the appropriate row of media content publishing interface 400. In an embodiment, the application may prompt the user to recapture the media content if the threshold number of media content items is not satisfied after the deletion. For example, if the user is prompted by the notification to capture 4 images of a home, and the user deletes one of the images using the delete selectable element of media content publishing interface 400, the application may prompt the user to capture another image of the home. In an embodiment, the order of the pictures may correspond to a particular view of the home, and the application may prompt the user to take the additional image from the view corresponding to the deleted image. For example, the notification may include information indicating that the user is to capture 4 images. When the user initiates image capture using the notification (e.g., via selection of selectable element 320 of FIG. 3), the application may prompt the user to capture the first image from the front of the home, a second image from the left side of the home, a third image from the right side of the home, and a fourth image from the back of the home. The application may associate the first image taken with the front of the home, the second image taken with the left side of the home, and so on. If the user subsequently deletes the third image using the media content publishing interface 400, the application may prompt the user to capture another image of the right side of the home.

In an embodiment, the application may enable the user to generate and send a notification to a person associated with the home, where the user initiates generation and sending of the notification based on at least part of the information contained in one or more items of captured media content. In an embodiment, the notification may be transmitted to a third party, such as a contractor, that is responsible for correcting the defect depicted in the image. For example, if trash is present in a captured image of the home, the user may interact with media content publishing interface 400 to generate a notification requesting that a contractor or community manager picking up the trash. In an embodiment, the notification may further allow the party that is to remedy the defect to capture the image and provide the image to the party that generated the notification of the defect, thereby allowing the image to be reviewed for compliance with the at least one rule, and approved for submission to the server and remote database. It is noted that in some embodiment, media content publishing interface 400 may be provided and used to approve media content for publication (e.g, to a user, such as a homeowner) after the captured media content has been provided to the database. For example, media content captured in response to a notification may be provided to the database, and then, prior to authorizing publication of the media content to a homeowner, a builder, contractor or other personnel administering the system (e.g., the system 100 of FIG. 1) may access media content publishing interface 400 to publish (e.g., approve or deny) the media content. When media content is denied, a notification may be generated and transmitted to the party that captured the denied media content, where the notification requests that the party recapture the media content, and may include information indicating why the previously captured content was denied. When the media content is approved, the media content may be viewed (e.g., by a homeowner) via a gallery interface, as described in more detail below.

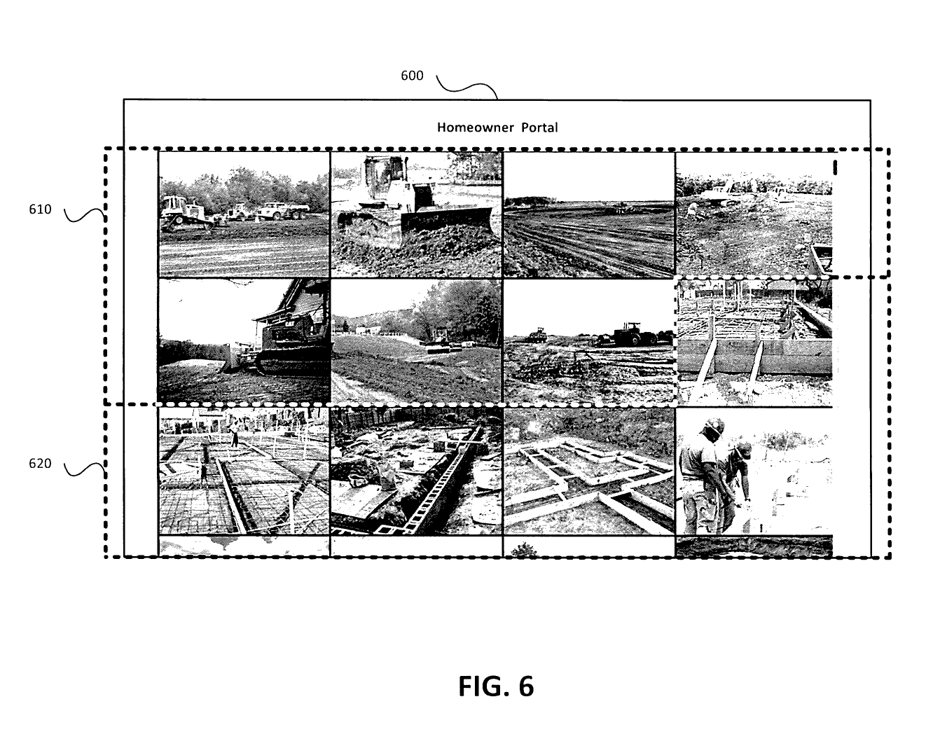

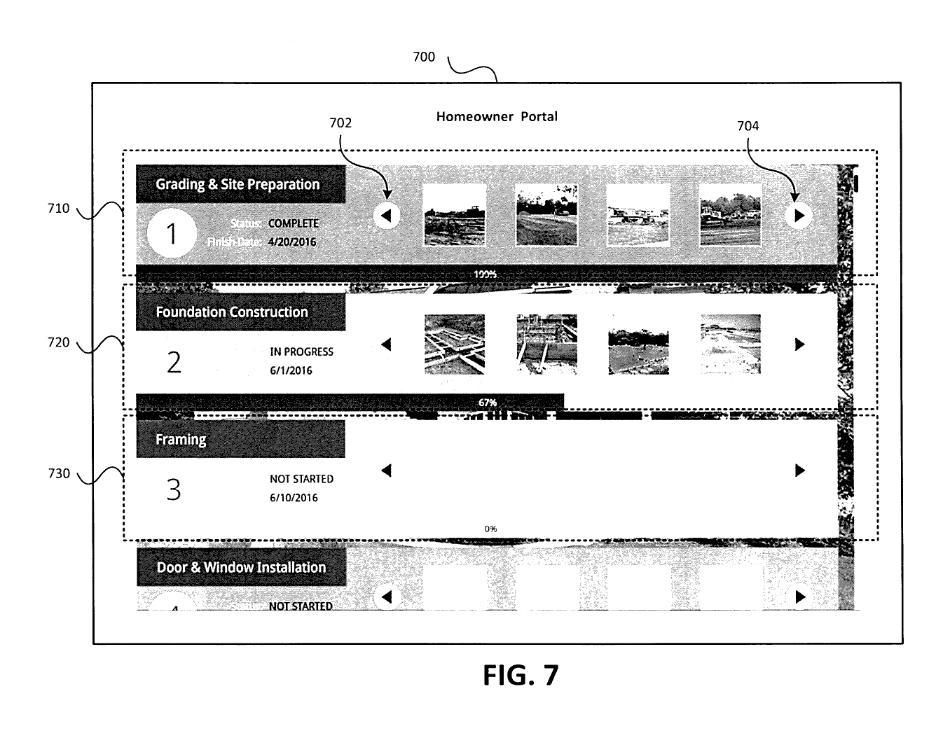

Referring back to FIG. 1, as explained above, database 120 may be configured to store items of media content, such as media content generated in response to a notification (e.g., notification 300 of FIG. 3). In an embodiment, media content stored at database 120 may be presented to a user via one or more galleries. For example, a home builder and/or contractor may capture media content representative of various aspects or features of a home as it is being constructed, and may illustrate the progress of the construction of the home. In an embodiment, the media content may be presented to a user, such as the homeowner, via one or more galleries. In an embodiment, the galleries may be presented to the user via an application (e.g., a web browser-based application or standalone application) executing on the user's device (e.g, homeowner device 130). Exemplary media content gallery interfaces for presenting a user with media content captured in accordance with embodiments are illustrated with reference to FIGS. 6 and 7, as described in more detail below.

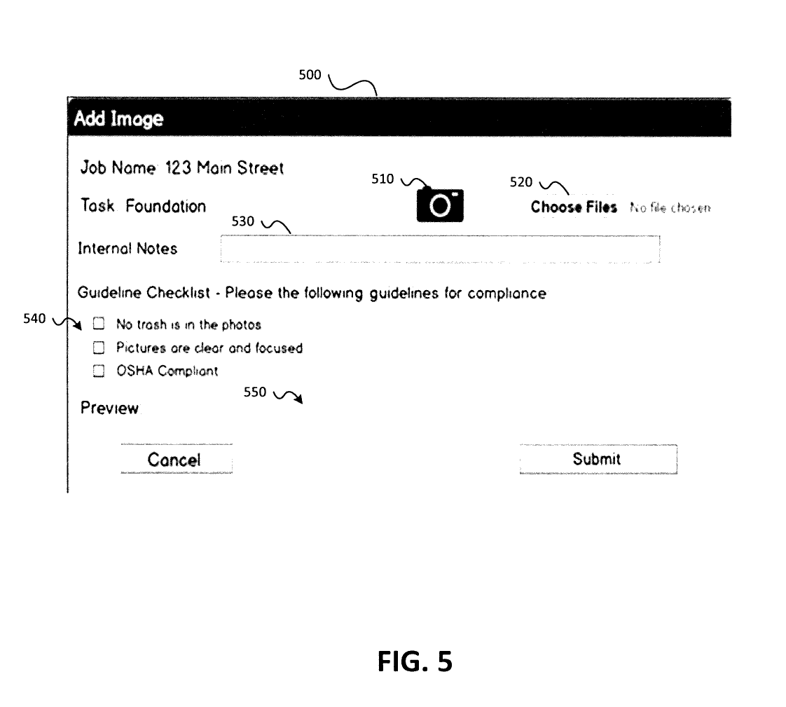

Referring to FIG. 5, a block diagram of another embodiment of a media content capture interface for reviewing and submitting media content in accordance with embodiments of the present disclosure is shown as a media content capture interface 500. In an embodiment, media content capture interface 500 may be presented in response to a selection of selectable element 320 of FIG. 3, and may provide functionality for allowing a user to capture media content associated with a home. As shown in FIG. 5, media content capture interface 500 includes a launch camera icon 510, a file selector icon 520, an internal notes input area 530, a rules compliance interface 540, and a preview area 550. The launch camera icon 510 may be selected to launch a camera application of the user's device, and the camera application may control a camera to capture one or more images associated with the task, as described above. In an embodiment, the task may be indicated in media content capture interface 500, as shown in the upper left portion of media content capture interface 500. It is noted that the particular location where the task information is presented may vary, and the location illustrated in FIG. 5 is provided for purposes of illustration, rather than by way of limitation.

Selection of file selector icon 520 may present a gallery of media content stored on the user's device, such as the device's camera roll or resident repository for media content captured using the device's camera. The user may interact with the gallery to select the particular images to be associated with the task and job identifier. Internal notes input area 530 may be used to input internal notes, such as the internal notes described above with reference to FIG. 4. In an embodiment, not shown in FIG. 5, media content capture interface 500 may also include an external notes input area, which may be used to input external notes, such as the external notes described above with reference to FIG. 4. Rules compliance interface 540 may provide the user with various controls (illustrated as check boxes in FIG. 5) that may be used to provide inputs indicating whether the selected media content items satisfy the one or more rules. Preview area 550 may present thumbnails representative of the one or more selected media content items. The user may review the thumbnails to verify the one or more rules are satisfied, and, in response to providing inputs indicating that the one or more rules are satisfied, a submit button (shown in the bottom right of media content capture interface 500) may be enabled. In an embodiment, selection of the submit button may initiate transmission of the selected media content items to a server (e.g., server 110 of FIG. 1) for storage in a database (e.g., database 120 of FIG. 1). In an additional or alternative embodiment, selection of the submit button may indicate that the selected media content items are to be transmitted to the server when the device is coupled to a network (e.g., a Wi-Fi network, etc.).

In an embodiment, the rules provided in rules compliance interface 540 (or the rules discussed above with reference to FIGS. 1-4) may be configured by an operator of a system, such as system 100 of FIG. 1. For example, the system may provide an interface that enables a user to configure the rules associated with particular tasks and media data capture processes. This means that the operator of the system may associate particular rules with particular tasks so that media data captured in connection with those tasks may be reviewed for compliance with the associated rules. In an embodiment, a party other than the operator of the system may specify one or more rules. For example, a contractor may specify one or more rules that are to be used by the contractor for verifying the content of media content prior to submitting the media content to the system. In an embodiment, the rules specified by the contractor may be applied in addition to any rules specified by the operator of the system.

Referring to FIG. 6 a block diagram of an embodiment of a gallery interface for presenting media content in accordance with embodiments of the present disclosure is shown as a gallery interface 600. As shown in FIG. 6, gallery interface 600 may provide a composite view of all media content that has been stored at a database (e.g., database 120 of FIG. 1) in connection with a single job identifier (e.g., a single home), and may not distinguish between media content associated with different tasks. For example media content items 610 may comprise media content representative of a grading and site preparation task for a home identified by a particular job identifier, and media content items 620 may comprise media content representative of a foundation construction task for the home identified by the particular job identifier. It is noted that additional media content items associated with additional tasks, such as framing, flooring installation, sheetrock installation, and the like, may be presented in additional portions of gallery interface 600, and may be viewed by scrolling down. Thus, gallery interface 600 may provide a homeowner with a convenient way to monitor the home construction progress without requiring the homeowner to visit the job site. In an embodiment, the homeowner may share the gallery of media content presented in gallery interface 600 with one or more additional persons, such as friends or family members, thereby allowing those additional people to see their home as it is being built.

Referring to FIG. 7 a block diagram of another embodiment of a gallery interface for presenting media content in accordance with embodiments of the present disclosure is shown as a gallery interface 700. As shown in FIG. 7, gallery interface 700 may media content that has been stored at a database (e.g., database 120 of FIG. 1) in connection with a single job identifier (e.g., a single home), but, unlike the gallery interface 600 described above with reference to FIG. 6, gallery interface 700 may distinguish between media content associated with different tasks. For example media content items 710 may comprise media content representative of a grading and site preparation task for a home identified by a particular job identifier, and media content items 720 may comprise media content representative of a foundation construction task for the home identified by the particular job identifier. It is noted that additional media content items associated with additional tasks, such as framing, flooring installation, sheetrock installation, and the like, may be presented in additional portions of gallery interface 700. For example, media content representative of a framing task may be presented at media content region 730. However, as will be described below, media content representative of the framing task has not been captured yet, and therefore, gallery interface 700 does not present any media content in media content region 730.

As illustrated in FIG. 7, gallery interface 700 may present additional information, other than media content. For example, gallery interface 700 may present status scheduling information indicating when a particular task is to be completed, and what the current status of a task is. For example, gallery 700 indicates that the current status of the grading and site preparation task is “complete” and was finished on Apr. 20, 2016. Additionally, gallery interface 700 indicates that the current status of the foundation construction task is “in progress” and is scheduled to be completed on Jun. 1, 2016, and indicates that the current status of the framing task is “not started” and is scheduled to be completed on Jun. 10, 2016. By providing status and scheduling information in addition to media content, gallery interface may provide the user (e.g., the homeowner) with a more detailed view of the progress of the construction of the home, and may relieve the homeowner of making trips to the construction site to view the progression of the home's construction, which may improve the safety of the construction site.

In an embodiment, the media content presented in connection with a particular task may include more media content items than will fit within a corresponding media content region. Media content view controls 702 and 704 may enable the user to scroll through the media content items to view additional media content items that may not be initially visible within the corresponding media content region. Thus, gallery interface 700 may provide a homeowner with a convenient way to monitor the home construction progress without requiring the homeowner to visit the job site. In an embodiment, the homeowner may share the gallery of media content presented in gallery interface 700 with one or more additional persons, such as friends or family members, thereby allowing those additional people to see their home as it is being built. It is noted that the particular media gallery interfaces for presenting media content captured in accordance with embodiments, as illustrated and described with reference to FIGS. 6 and 7, are provided for purposes of illustration, rather than by way of limitation, and that embodiments of the present disclosure are not to be limited to the particular gallery interfaces illustrated and described herein. In an embodiment, gallery interface 600 of FIG. 6, and/or gallery interface 700 of FIG. 7 may be accessed using home management interface 200 of FIG. 2. For example, a user may use home progress navigation element 220 to access gallery interface 500, gallery interface 600, and/or other gallery interfaces configured to present information demonstrating or illustrating progression of a home's construction.

Referring back to FIG. 1, as construction of the home progresses, database 120, and more particularly media data 122, may be populated with various items of media content associated with the home as notifications (e.g., notification 300 of FIG. 3) are provided to one or more entities (e.g., personnel of the home builder, or a contractor working on the home's construction), as described above. Additionally, during the construction process, home data 126 may be captured. In an embodiment, home data 126 may be generated using one or more of the techniques described in U.S. patent application Ser. No. 14/250,339, filed on Apr. 10, 2014, and entitled “CLOSED NETWORK PO DETAIL COMMUNICATION,” the contents of which are incorporated herein by reference in their entirety. For example, as a contractor installs appliances in the home, the contactor may capture a serial number and a model number of the appliance that was installed in the home, and that information may be stored as home data 126 in connection with a job identifier corresponding to the home. Information for other structures and components of the home may also be recorded, such as paint colors used in the home, information identifying the carpet and other flooring materials used in the home, etc. may also be stored as home data 126. Thus, when construction of the home is complete, database 120 may include information that completely details the home and its contents, including media data 122, which includes items of media content representative of one or more tasks completed during the construction process, and home data 126, which include information identifying the contents and structural components of the home. In an embodiment, home data 126 may be accessed and/or viewed using home inventory navigation element 230 of home management interface 200 of FIG. 2.

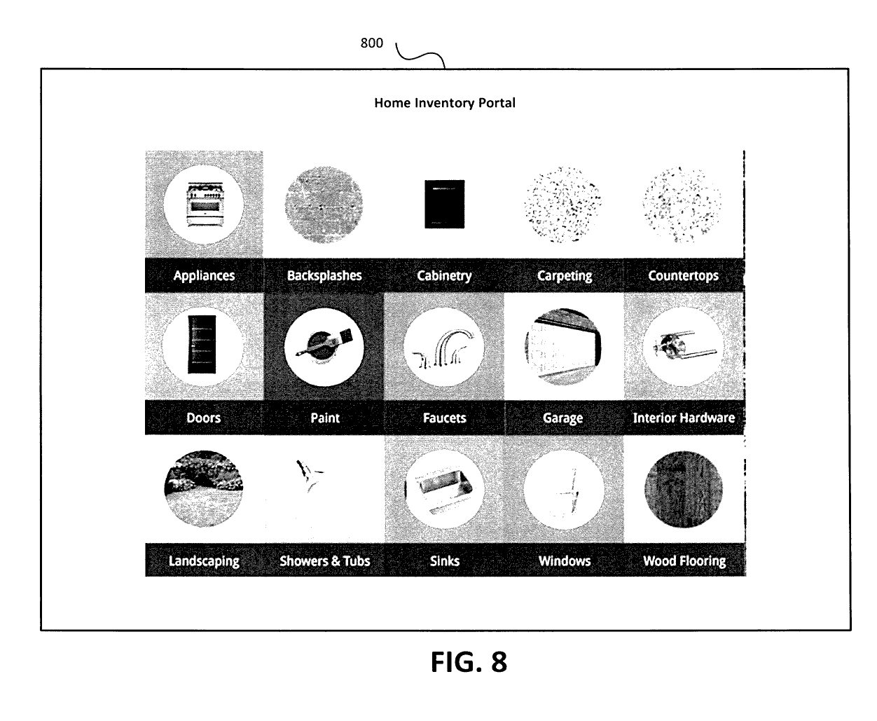

For example, and referring to FIG. 8, a home inventory interface for accessing and viewing home data representative of contents and components of a home is shown as a home inventory interface 800. As shown in FIG. 8, home inventory interface 800 may present a menu of selectable elements associated with various item categories (e.g., categories of components and structures of the home). A user (e.g., a homeowner) may interact with, or select, various ones of the selectable elements to view items of the home for a particular item category. For example, selection of the appliances selectable element may present information that identifies each of the appliances installed in the home. Additionally, the information may identify the date on which each of the appliances were installed in the home, the entity that installed each appliance, the brand of the appliance, the model and serial number of the appliances, and other information about the appliances of the home. As another example, selection of the paint selectable element may present information that identifies one or more colors of paint used to paint the interior and/or exterior of the home. In an addition to identifying the colors of paint, the information may identify a brand for each color of paint, a type of paint (e.g., semi-gloss, eggshell, gloss, etc.), the rooms in the home where each color of paint was used and what portion of each room the color of paint was used (e.g., wall, ceiling, baseboard/crown molding, cabinets, etc.). Thus, home inventory interface 800 may provide the homeowner with a comprehensive and detailed view of the contents of a home.

In an embodiment, the information presented in response to interaction between the user and home inventory interface 800 may include information associated with previous contents of the home. For example, as the homeowner replaces contents of the home, such as a water heater, an appliance, or other item, the homeowner may update home data 126 to include information of the replacement item, and that information may be presented to the user through interaction with home inventory interface 800. Thus, home inventory interface 800 may allow the user to track the history of the home's contents, which may be beneficial when the user sells the home. For example, it is not uncommon for present day homeowners to buy a home where the home's current owner does not know when the last time the water heater was replaced, how old the roof is, etc. This information can be important to the new homeowner, and may increase or decrease the homeowner's costs. For example, insurance companies often desire to know the age of a room when determining rates for a homeowner's insurance policy. If the home's roof is relatively new, the rate may be substantially lower than when the roof is really old. Thus, having a historical record of the maintenance performed on the home, as may be provided by the home inventory interface 800, may provide homeowners with a more accurate view of the home, and better estimate the costs of owning the home, such as obtaining a more accurate homeowner's insurance policy quote, or anticipating contents of the home that may need to be replaced.

Referring back to FIG. 1, in addition to providing information about the contents of a home and providing media content detailing the construction of the home, system 100 may facilitate one or more processes for managing warranty claims for the home. In an embodiment, warranty data 124 may be generated based on information included in home data 126. For example, when information is added to home data 126, server 110 may determine whether an item (e.g., an appliance or other home component) associated with the information is subject to a warranty (e.g., a manufacturer warranty or some other form of warranty, such as a home builder warranty), and, if server 110 determines that the item is subject to a warranty, may record the warranty as warranty data 124. When the homeowner takes ownership of the newly built home, the information stored in database 120 may provide a comprehensive record of all of the home's contents, including the warranty information. Subsequently, if a component or structure of the home fails, the homeowner may consult the home information stored at database 120 to determine whether that component or structure is covered under warranty (e.g., using warranty data 124).

In an embodiment, the user may access warranty data 124 using home management interface 200 of FIG. 2. For example, and referring back to FIG. 2, the user may select home warranty selectable element 240, which may initiate presentation of one or more GUIs that enable the user to view information associated with contents and structures of the home that are covered, or were covered, under a warranty. The user may view warranty data 124 pertaining to the home using home warranty navigation element 240, and may initiate one or more warranty claims via a GUI provided by system 100 (or a web browser-based or standalone application that interfaces with system 100).

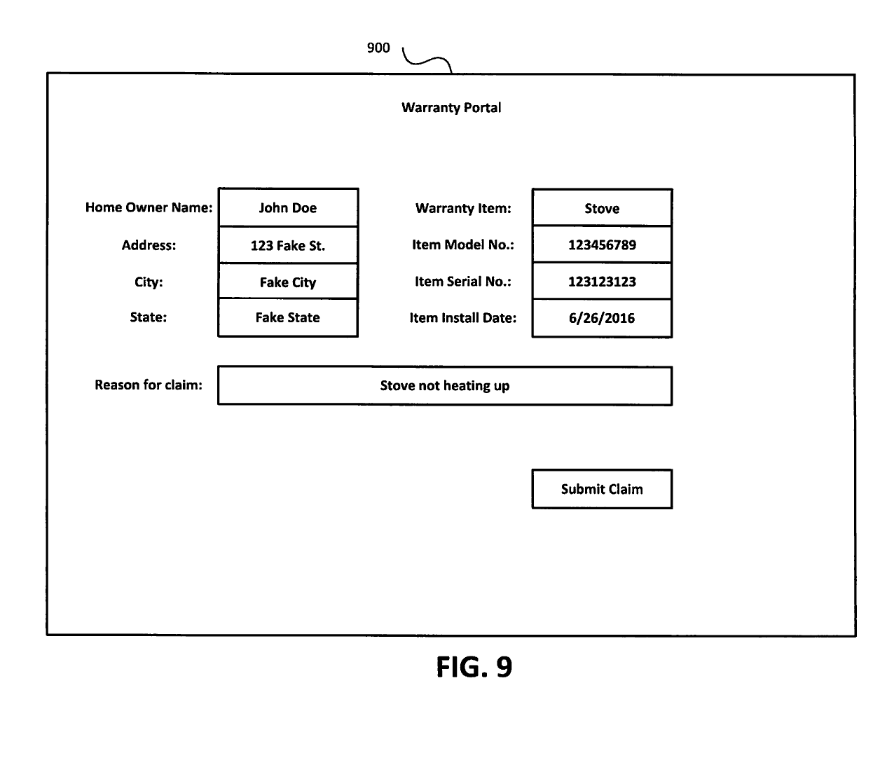

For example, and referring to FIG. 9, a block diagram illustrating an embodiment of a warranty interface for submitting a warranty claim is shown as a warranty interface 900. It is noted that the particular information and configuration of warranty interface 900 is provided for purposes of illustration, rather than by way of limitation, and that embodiments of the present disclosure may utilize interfaces that include more or less information, or different information than that shown in FIG. 9. As shown in FIG. 9, warranty interface 900 includes a plurality of data fields that may be used to submit a warranty claim for repair. In an embodiment, at least a portion of the data fields of warranty interface 900 may be automatically populated using information stored in a database (e.g., database 120 of FIG. 1). For example, because the database already has all of the information regarding the contents of the home, a user (e.g., homeowner) may only have to provide inputs to select the warranty item and explain the reason for the warranty claim request, and all other fields may be populated automatically, thus saving the homeowner the hassle of trying to locate that information. Warranty interface 900 may provide a dropdown menu, a popup menu, or other type of data input technique to allow the user to select the warranty item. In an embodiment where a menu is used, the menu choices may be determined from information (e.g., warranty data 124) stored in the database, which may identify items or contents of the home that are actively covered by a warranty. The user may then select the submit claim button to submit the warranty claim to the system. When the system receives the warranty claim, the system may store the warranty claim in the database (e.g., as part of warranty data 124). In an embodiment, the system may automatically determine the appropriate destination for the claim, which may be the home builder, a manufacturer of the item, a contractor that installed the item, or another party, and may generate one or more warranty notifications, which may be transmitted to the destination for the claim. In an additional or alternative embodiment, the system may provide the warranty claim to the home builder, and the home builder may determine whether the home builder should handle processing of the claim, or whether another party should handle processing of the claim.

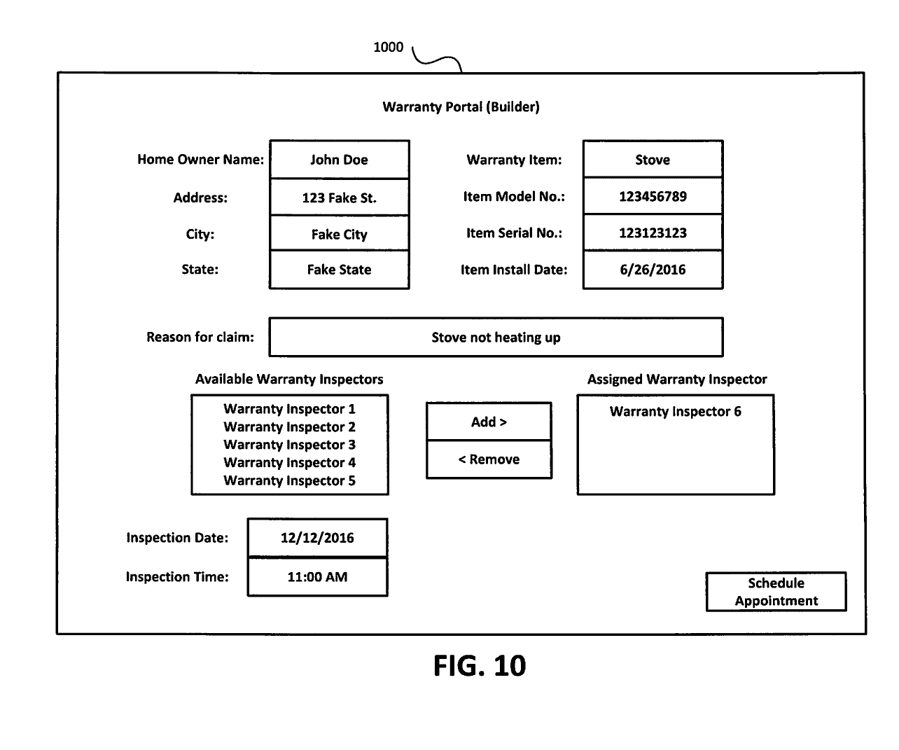

Upon receiving notice of the warranty claim, the entity handling the claim processing may schedule an appointment to inspect the item associated with the warranty claim. Referring to FIG. 10, a block diagram of an embodiment of a warranty inspection interface for scheduling a warranty inspection is shown as a warranty inspection interface 1000. It is noted that the particular information and configuration of warranty inspection interface 1000 is provided for purposes of illustration, rather than by way of limitation, and that embodiments of the present disclosure may utilize interfaces that include more or less information, or different information than that shown in FIG. 10. As shown in FIG. 10, warranty inspection interface 1000 may present the information of the warranty claim (e.g, the information provided via the warranty interface 900), and may enable the entity handling the claim to assign one or more warrant inspectors to visit the home and inspect the item to determine whether the reasons for the claim are valid, and whether the item should be repaired under the warranty. Additionally, warranty inspection interface 1000 may allow the entity handling the claim to schedule an appointment between the assigned warranty inspector and the homeowner. Once the entity handling the claim has assigned the warranty inspector, and selected a time and date for the inspection, the entity may schedule the appointment by selecting the schedule appointment button. In an embodiment, selection of the schedule appointment button may initiate transmission of a message to the assigned inspector and to the homeowner, notifying them of the appointment. The message may be a text message, an e-mail message, an automated voice response system message, an instant message, another type of message, or a combination thereof.

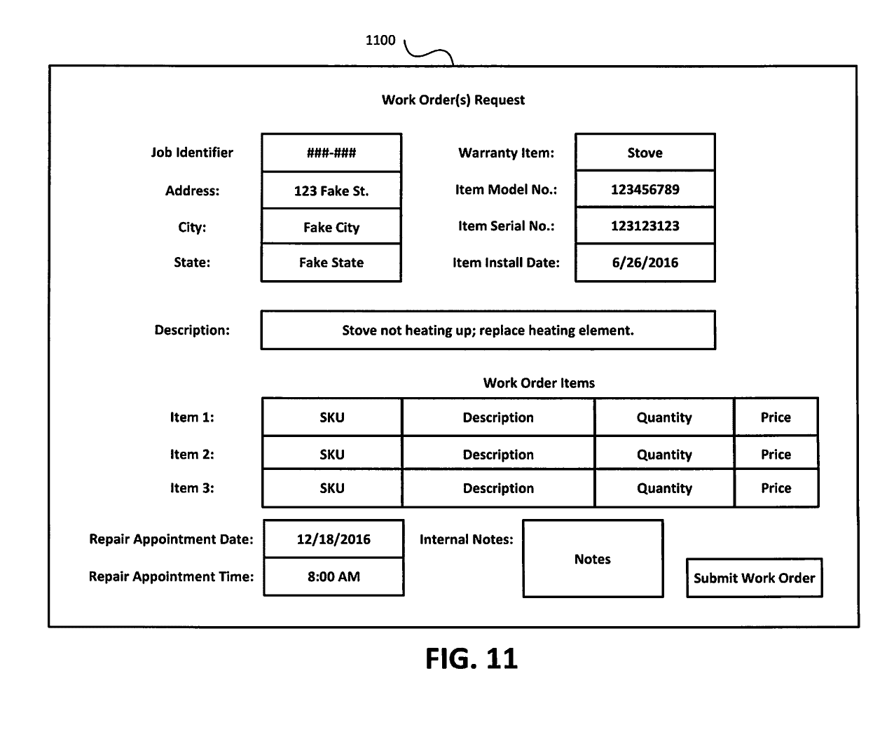

During the inspection, the assigned warranty inspector may evaluate the item and its state of operation to determine whether the problem with item is covered under the warranty. If the problem is not covered under the warranty, the assigned inspector may provide information to the system (e.g., system 100 of FIG. 1) indicating the reason the warranty claim was denied. However, if the problem is covered under the warranty, the assigned warranty inspector, or another party, such as the home builder, may generate one or more work orders for repairing the item under the warranty. Referring to FIG. 11, a block diagram of a work order request interface according to embodiments of the present disclosure is shown as a work order interface 1100. It is noted that the particular information and configuration of work order interface 1100 is provided for purposes of illustration, rather than by way of limitation, and that embodiments of the present disclosure may utilize interfaces that include more or less information, or different information than that shown in FIG. 11. As shown in FIG. 11, work order interface 1100 may include warranty claim information (e.g., job identifier, address/city/state, warranty item, model and serial number s, installation date, and description). In an embodiment, at least a portion of the warranty claim information may have been obtained from information provided via warranty interface 900. In an embodiment, at least a portion of the warranty information may have been obtained from information provided by the assigned warranty inspector. For example, as shown in FIG. 11, the description indicates that the heating element of the stove needs to be replaced. This information may have been input by the assigned warranty inspector following his/her inspection of the home.

Work order interface 1100 may allow an entity to select one or more work order items associated with the warranty repair. The work order items may include items associated with labor, parts, or other information descriptive of the anticipated aspects of the warranty repair. In an embodiment, a work order item may instruct the person performing the warranty repairs to capture media content associated with the repair, such as a picture of the item being repaired, or portion of the item (e.g., a part that is being replaced). In an embodiment, a notification may be provided to the person performing the warranty repairs and the notification may facilitate capturing of the media content using the techniques described above with respect to notification 300 of FIG. 3, or media content capture interface 500 of FIG. 5, or another technique. The media content may be stored at a database (e.g, database 120 of FIG. 1). In an embodiment, the notification associated with the work order may be transmitted to the party performing the repairs around the scheduled repair appointment time. In an additional or alternative embodiment, the notification may be transmitted to the party in advance of the scheduled time. In an embodiment, multiple work orders may be created for a single warranty claim. For example, if the warranty claim/repair is associated with a plumbing leak, one or more plumbing components (e.g., a faucet, a shower head, a supply line, a valve, etc.) may need to be repaired or replaced, which may require a plumber to open up a wall to access the area to be repaired. In such instances, a first work order may be created to repair the plumbing components, and a second work order may be created to repair any sheetrock that was damaged. Further, a third work order may need to be created to paint the sheetrock after it has been repaired. One or more of the different work orders may have the same appointment date and same time, or may have different appointment dates and times, depending on the work to be performed, and whether a task to be completed for one of the work orders is dependent upon completion of another task to be completed for a different one of the work orders (e.g., painting the sheetrock may need to be scheduled for a different day to allow sufficient time for the mud and texture applied during the sheetrock repair to dry prior to painting).

As shown in FIG. 11, work order interface 1100 may enable the entity creating the work order(s) to schedule an appointment for the repairs, and provide internal notes if desired. The internal notes may be communicated to the repair technician, but may not be made available to the homeowner. In an embodiment, external notes (not shown in FIG. 11) may also be added, and the external notes may include information that is to be communicated to the homeowner. For example, once the work order(s) is submitted, a message (e.g., an e-mail, a text message, an automated voice response message, an instant message, or another type of message) may be communicated from the system (e.g., system 100) to the homeowner, notifying the homeowner of the repair appointment date and time. In an embodiment, the appointments may be viewed using the application (e.g., the web browser-based or standalone application) executing on the user's device. For example, the user may navigate the home management interface 200 to a home warranty portal by selecting home warranty selectable element 240 of FIG. 2, which may initiate presentation of information associated with pending work orders, warranty claims, or other information (e.g., warrantied items in the home, past warranty claims and repairs, and the like). In an embodiment, the entity creating the work orders, and/or entities making repairs under the work orders, may also view a historical record of a home's warranty history/pending repairs and work orders (e.g., using home management interface 200 as described above). However, the information presented to the homeowner, and the information presented to the entity creating the work orders or making repairs under the work orders may be different. For example, when viewing a particular warranty claim, the homeowner may see a schedule corresponding to the work orders that have been created, and may also see any external notes associated with each of the work orders. The external notes may inform the homeowner of the types of repairs to be performed for each work order or other information, such as the name and contact information of the entity that will be making the repair, etc. Using internal and external notes may enable the home builder to communicate with one or more contractors regarding the work order(s) and repair(s) without getting the homeowner involved, and then communicate information of relevance regarding the work order(s) and/or repair(s) to the homeowner using the external notes.

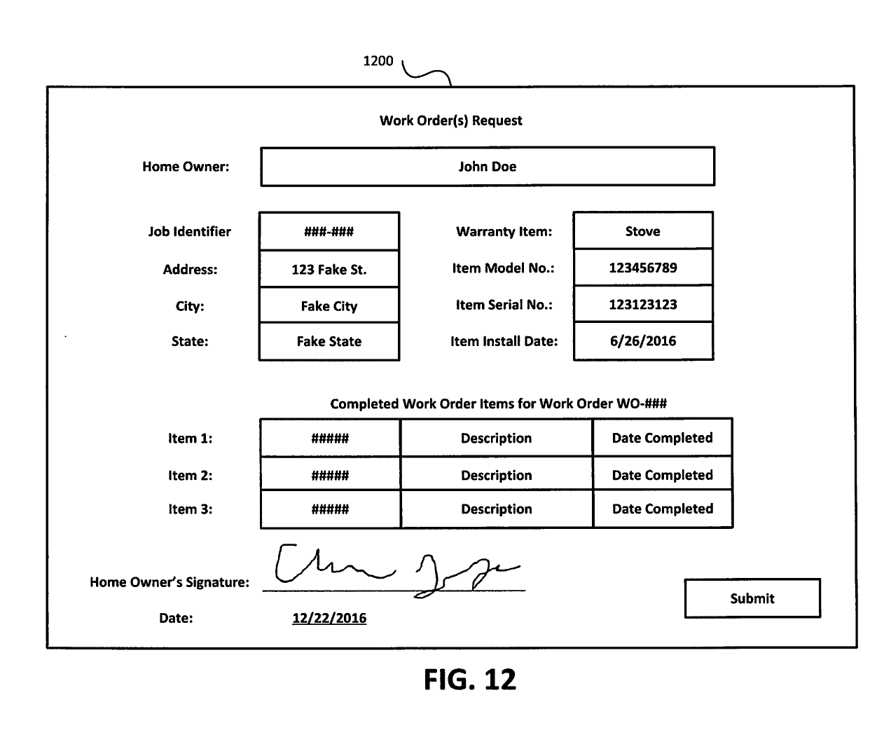

As the warranty repairs are completed, the homeowner may be asked to sign an electronic document to demonstrate that the warranty repairs for one or more work orders have been completed. In an embodiment, the party making the warranty repairs may print a copy of the work order, and the homeowner may sign the work order upon completion of the repairs to be made under that work order. In an additional or alternative embodiment, the signature may be provided in electronic form at a user device (e.g., builder device 140 and/or contractor device 150). For example, and referring to FIG. 12, a block diagram of a completed work order interface in accordance with embodiments of the present disclosure is shown as a completed work order interface 1200. As shown in FIG. 12, completed work order interface 1200 may identify the homeowner (e.g., John Doe), the location where the work was performed (e.g., job identifier, address/city/state, etc.), the reason the work order was created (e.g, warranty item, model and serial numbers, etc.), and may include a work order identifier (e.g, information identifying the work order, shown as “WO-###”), items of the work order that have been completed. After all of the items of a work order have been completed, the party completing the work order items, or at least the party completing the last incomplete work order item, may present the homeowner with completed work order interface 1200 and request that the homeowner sign the completed work order. In an embodiment, completed work order interface 1200 may present a listing of completed work order items, including a description of the work performed, and a date that the work was completed. When requesting that the homeowner sign completed work order interface 1200, the party requesting the homeowner's signature may review each completed work order item with the homeowner, explaining what work was done, any instructions for future care and/or maintenance of the repaired item, etc. The homeowner, once satisfied that the warranty repairs have been completed for the work order, may then provide a signature and date to completed work order interface 1200, and the signed work order may then be submitted to a system, such as system 100 of FIG. 1. The signed work order may be stored in a database, such as database 120. In an embodiment, the signed work order may be stored as warranty data 124. In an additional or alternative embodiment, the signed work order may be stored as home data 126. In another additional or alternative embodiment, portions of the signed work order may be stored as both warranty data 124 and home data 126.

The various interfaces described with reference to FIGS. 9-12, which may be provided by embodiments of system 100 of FIG. 1, may simplify the warranty claim process. For example, as explained above, all relevant information about items of a home that are covered under a warranty may be automatically stored at database 120 (e.g, as warranty data 124), and the homeowner may easily view whether an item of a home is covered under a warranty (e.g., using home management interface 200 and home warranty selectable element 240 of FIG. 2). This may eliminate the need for the homeowner to maintain paper records, such as warranty cards, which may be easily lost or misplaced, which could prevent the homeowner from receiving coverage under the warranty. Additionally, allowing the homeowner to digitally sign completed work orders generated for repairs made under a valid warranty claim (e.g., a warranty claim for which an inspection was performed by an assigned warranty inspector and determined to be a covered warranty claim) may improve the warranty repair process. For example, a contractor may perform the repairs and obtain the homeowner's signature. This signed completed work order may then be immediately provided to one or more entities responsible for covering the costs, which may increase the speed at which the contractor is paid for completing the repairs. Also, a copy of the signed completed work order may be stored at database 120, thereby preventing the signed work order from becoming lost or misplaced.

The data (e.g., media data 122, warranty data 124, and home data 126) stored at database 120 may be stored in association with the job identifier which, as explained above, identifies the home corresponding to the data. This enables the different types of data to be provided to, and accessed from system 100, and subsequently presented in the various galleries and interfaces described above with reference to FIGS. 2-11. Thus, system 100 provides a simple solution to capturing and storing home construction progress information, and provide a convenient and simple way for a homeowner or homeowner to monitor construction of a home, or maintain records of different types of maintenance performed on the home. Further, operations of system 100 require that the information stored to system 100 be reviewed for compliance with one or more rules, which may motivate various personnel involved in the construction of the home to be safer, maintain a cleaner job site, and review their work more carefully (e.g., to prevent one of the images from showing something was constructed improperly), which may improve the safety of the construction personnel, reduce worksite injuries, and improve the quality of the home.

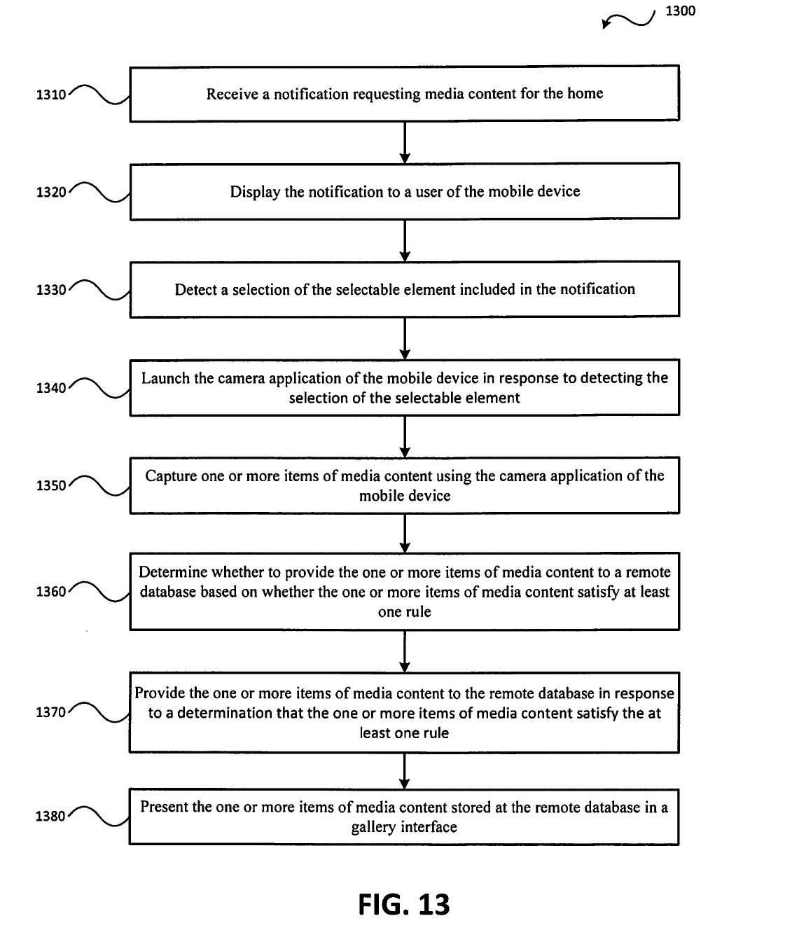

Referring to FIG. 13, a flow diagram of an embodiment of a method for capturing and providing media content associated with a home in accordance with embodiments of the present disclosure is shown as a method 1300. In an embodiment, operations and steps of method 1300 may be performed by a user device, such as homeowner device 130, builder device 140, or contractor device 150 of FIG. 1. In an embodiment, an application (e.g., the application(s) stored at homeowner device 130, builder device 140, or contractor device 150 of FIG. 1) may be stored as instructions that may be executed by one or more processors to perform the operations or steps of method 1300.

At 1310, method 1300 includes receiving a notification requesting media content for the home. In an embodiment, the notification may be notification 300 of FIG. 3. The notification may include an identifier that identifies the home, and may include a selectable element that, when selected, controls a camera application of a mobile device to capture the media content. In an embodiment, the selectable element may be selectable element 320 of FIG. 3. In an additional or alternative embodiment, the selectable element included in the notification may be camera icon 510 of FIG. 5. In an embodiment, the media content may be captured using one or more of the various techniques described with reference to FIGS. 3-5. At 1320, method 1300 includes displaying the notification to a user of the mobile device. In an embodiment, the notification may be displayed to the user via an interface. For example, the notification may be displayed in response to selection of the notification from a list of notification presented in an interface (e.g., an interface presented in response to selection of alerts selectable element 210 of FIG. 2). At 1330, method 1300 includes detecting a selection of the selectable element included in the notification, and, at 1340, launching the camera application of the mobile device in response to detecting the selection of the selectable element. In an embodiment, the camera application may be launched as described above with reference to FIG. 3 or 5.

At 1350, method 1300 includes capturing one or more items of media content using the camera application of the mobile device. In an embodiment, method 1300 may include operations (not shown in FIG. 13) to automatically detect the number, and location, of the captured media content items, as described above with reference to FIG. 3. In an additional or alternative embodiment, method 1300 may include operations to allow the user to locate and select the one or more media content items, as described above with reference to FIG. 5. At 1360, method 1300 includes determining whether to provide the one or more items of media content to a remote database based on whether the one or more items of media content satisfy at least one rule. In an embodiment, the rules may correspond to one or more of the rules described above with respect to FIG. 1. In an embodiment, a determination of whether to provide the one or more items of media content to the remote database may be performed automatically. In an additional or alternative embodiment, the determination of whether to provide the one or more items of media content to the remote database may be performed by the user. In still another additional or alternative embodiment, the determination of whether to provide the one or more items of media content to the remote database may be performed in part by the user, and automatically. The remote database may store items of media content for presentation in one or more galleries. In an embodiment, the remote database may be database 120 of FIG. 1, and the items of media content may be stored as the media data 122 of FIG. 1. At 1370, method 1300 includes providing the one or more items of media content to the remote database in response to a determination that the one or more items of media content satisfy the at least one rule. In an embodiment, the one or more items of media content, when provided to the remote database, may be stored in association with the identifier that identifies the home. At 1380, method 1300 includes presenting the one or more items of media content stored at the remote database in a gallery interface. In an embodiment, the one or more items of media content may be presented in GUI 600 of FIG. 6. In an additional or alternative embodiment, the one or more items of media content may be presented in GUI 700 of FIG. 7. In still another additional or alternative embodiment, the one or more items of media content may be presented in an interface presented in response to selections made via home inventory interface 800 of FIG. 8.

It is noted that while various examples of embodiments of interfaces have been disclosed, such interfaces, including their contents and configuration, are provided for purposes of illustration, rather than by way of limitation, and embodiments of the present disclosure should not be limited to the particular interfaces and configurations/contents illustrated herein. Further, although embodiments have been primarily described in connection with construction of a new home, embodiments may be readily suited for structures other than homes, such as office buildings or other structures, such as boats, cars, planes, roads, bridges, and the like.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

1. A non-transitory computer-readable storage medium storing instructions that, when executed by one or more processors, cause the one or more processors to perform operations for capturing and providing media content associated with a home, the operations comprising:
receiving a notification requesting media content for the home, wherein the notification includes an identifier that identifies the home, and includes a selectable element that, when selected, controls a camera application of a mobile device to capture the media content;
displaying the notification to a user of the mobile device;
detecting a selection of the selectable element included in the notification;
in response to detecting the selection of the selectable element, launching the camera application of the mobile device;
capturing one or more items of media content using the camera application of the mobile device;
determining whether to provide the one or more items of media content to a remote database based on whether the one or more items of media content satisfy at least one rule, wherein the remote database stores items of media content for presentation in one or more galleries;
in response to a determination that the one or more items of media content satisfy the at least one rule, providing the one or more items of media content to the remote database, wherein the one or more items of media content, when provided to the remote database, are stored in association with the identifier that identifies the home; and
presenting the one or more items of media content stored at the remote database in a gallery interface.

2. The non-transitory computer-readable storage medium of claim 1, wherein determining whether to provide the one or more images to the remote database comprises:
presenting the at least one rule to the user of the mobile device; and
receiving at least one input from the user, the at least one input indicating whether the at least one rule is satisfied.

3. The non-transitory computer-readable storage medium of claim 2, wherein the at least one rule specifies a threshold image quality.

4. The non-transitory computer-readable storage medium of claim 2, wherein the at least one rule indicates whether contents of the media content comply with laws and/or regulations promulgated by a governmental agency, a professional organization, or both.

5. The non-transitory computer-readable storage medium of claim 2, wherein the at least one rule indicates whether an item of media content depict an undesired item.

6. The non-transitory computer-readable storage medium of claim 1, wherein determining whether to provide the one or more items of media content to the remote database is performed automatically by an application executing on the mobile device without human intervention based on the at least one rule.

7. The non-transitory computer-readable storage medium of claim 6, wherein the notification includes task information that indicates a threshold number of items of media content to be captured, and specifies one or more views of the home that are to be depicted in the media content.

8. The non-transitory computer-readable storage medium of claim 1, wherein the operations further comprise sending an additional notification to a person associated with the home, the additional notification based on at least part of the information contained in the one or more items of media content.

9. The non-transitory computer-readable storage medium of claim 1, wherein the one or more items of media content comprise work progress information for the home.

10. The non-transitory computer-readable storage medium of claim 1, wherein the one or more items of media content comprise warranty information corresponding to at least one item of the home.

11. The non-transitory computer-readable storage medium of claim 1, wherein the operations further comprise displaying a request to the user of the mobile device to capture at least one additional item of media content representative of the home in response to a determination that none of the previously captured one or more items of media content satisfy the at least one rule.

12. A method for capturing and providing media content depicting construction of a home, the method comprising:
providing an application to a mobile device, the application configured to:
receive a notification requesting media content for the home, wherein the notification includes an identifier that identifies the home, and includes a selectable element that, when selected, controls a camera application of a mobile device to capture the media content;
display the notification to a user of the mobile device;
detect a selection of the selectable element included in the notification;
in response to detecting the selection of the selectable element, the camera application of the mobile device;
capture one or more items of media content using the camera application of the mobile device;
determine whether to provide the one or more items of media content to a remote database based on whether the one or more items of media content satisfy at least one rule, wherein the remote database stores items of media content for presentation in one or more galleries; and
provide the one or more items of media content to the remote database in response to a determination that the one or more items of media content satisfy the at least one rule, wherein the one or more items of media content, when provided to the remote database, are stored in association with the identifier that identifies the home; and
receiving the one or more items of media content from the mobile device via the application installed on the mobile device;
storing the one or more items of media content at the database, wherein the one or more items of media content are stored in association with the identifier that identifies the home; and
presenting the one or more items of media content stored at the remote database in a gallery interface.

13. The method of claim 12, further comprising:
generating the notification; and
sending the notification to the mobile device via a network.

14. The method of claim 12, further comprising sending an additional notification to a person associated with the home, the additional notification based on at least part of the information contained in the one or more items of media content.

15. The method of claim 14, wherein the one or more items of media content comprise work progress information for the home during its construction.

16. The method of claim 14, wherein the application includes one or more interfaces for managing, modifying, updating, and viewing the media content stored at the remote database.

17. A system for capturing, managing, and distributing information and media content for a home, the system comprising:
a server configured to:
selectively provide a first interface or a second interface to a user based on login information, wherein:
the first interface is provided when the login information indicates that the user is a homeowner, the first interface configured to:
provide access to one or more gallery interfaces comprising media content associated with the homeowner's home;
provide access to a homeowner warranty interface configured to: receive inputs from a homeowner for placing a warranty claim for at least one item of the home; provide information regarding one or more warranty claims placed by the homeowner; and provide a notification interface for providing one or more notifications regarding the home to the homeowner; and
the second interface is provided when the login information indicates that the user is a home builder, the second interface configured to:
provide access to a home builder warranty interface configured to: receive inputs for managing one or more warranty claims placed by homeowners;
provide access to a work order interface for creating work orders associated with work tasks to be completed for a home built by the home builder,
wherein various interfaces provided via the first interface and second interface provide additional information to both the homeowner and the home builder, and wherein different ones of the various interfaces hide at least a portion of the additional information from the homeowner, but not the home builder.

18. The system of claim 17, wherein the server is further configured to selectively provide a third interface to the user based on the login information when the login information indicates that the user is a contractor.

19. The system of claim 17, wherein at the server is configured to generate and transmit notifications requesting media content for the home, wherein each of the notification includes an identifier that identifies the home, and includes a selectable element that, when selected, controls a camera application of a mobile device to capture the media content.
